(19) United States
(12) Patent Application Publication
(10) Pub. No.: US 2005/0226006 A1
(43) Pub. Date: Oct. 13, 2005

(54) Decoration board of night light assembly

(76) Inventor: Sheng Chao Chen, Wugu Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/822,743

(22) Filed: Apr. 13, 2004

(51) Int. Cl. F21V 21/08

(52) U.S. Cl. 362/641

(57) ABSTRACT

A night light assembly includes a light source, such as an electrical bulb and a cold light panel, and a decoration board removably attached to the light source. The decoration board includes a mount portion having a pair of resilient arms forming a clip for removably attaching the decoration board to the light source at any selected orientation and a receiving section including a resilient retention tab with a receiving slot defined therebetween to receive and retain a board portion therein. The board portion forms decoration patterns, which can be planar, raised or recessed. When the decoration board is attached to the light source by the clip, the board portion is positioned to allow light from the light source to transmit therethrough for projecting the decoration patterns to the space in any desired direction.

### BACKGROUND OF THE INVENTION

1. Field of the Invention

The present invention generally relates to a night light that emits off weak light for illumination in dark environments, and in particular to a decoration board of a night light that is removable for replacement with decoration boards of different patterns.

2. The Related Art

A night light is commonly used in a dark environment for giving off dim light for indication purposes. Most of the known night lights have poor and simple designs, comprising an illuminator, such as a small electrical bulb and a cold light panel. Such a design is simple and is not appealing to the general consumers. To overcome such a problem, some night lights are provided with a shade on which decoration may be formed. The shade, however, is fixed to the night light, making it difficult, if not impossible, to replace with shades of different decoration patterns.

Further, the conventional designs of night light suffer another drawback, that is the direction in which light beams projects from the night light cannot be changed or adjusted because the bulb or cold light plate is completely surrounded by the shade. This makes it difficult to selectively project the light beam in a particular direction only. As a consequence, the conventional night light only serves as a lighting or indication device and does not function as a decoration device.

Thus, the present invention is aimed to provide a night light that overcomes the drawbacks of the conventional designs.

### SUMMARY OF THE INVENTION

Thus, a primary objective of the present invention is to provide a night light comprising a light source giving off light and a decoration board forming decoration patterns through which the light transmits and projects the pattern in a particular direction.

Another objective of the present invention is to provide a night light comprising a light source giving off light through a removable decoration board having decoration patterns, the decoration board being exchangeable to allow change of different patterns.

To achieve the above objectives, in accordance with the present invention, there is provided a night light assembly comprising a light source, such as an electrical bulb and a cold light panel, and a decoration board removably attached to the light source. The decoration board comprises a mount portion having a pair of resilient arms forming a clip for removably attaching the decoration board to the light source at any selected orientation and a receiving section including a resilient retention tab with a receiving slot defined therebetween to receive and retain a board portion therein. The board portion forms decoration patterns, which can be planar, raised or recessed. When the decoration board is attached to the light source by the clip, the board portion is positioned to allow light from the light source to transmit therethrough for projecting the decoration patterns to the space in any desired direction.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a decoration board of a night light assembly constructed in accordance with a first embodiment of the present invention;

FIG. 2 is an exploded view of the decoration board of the present invention;

FIG. 3 is an exploded view of a night light assembly to which the decoration board is combined;

FIG. 4 is similar to FIG. 3 but showing a night light assembly incorporating a decoration board in accordance with a second embodiment of the present invention; and

FIG. 5 is similar to FIGS. 3 and 4 but showing a night light assembly incorporating a decoration board in accordance with a third embodiment of the present invention.

### DETAILED DESCRIPTION OF THE PREFERRED EMBODIMENTS

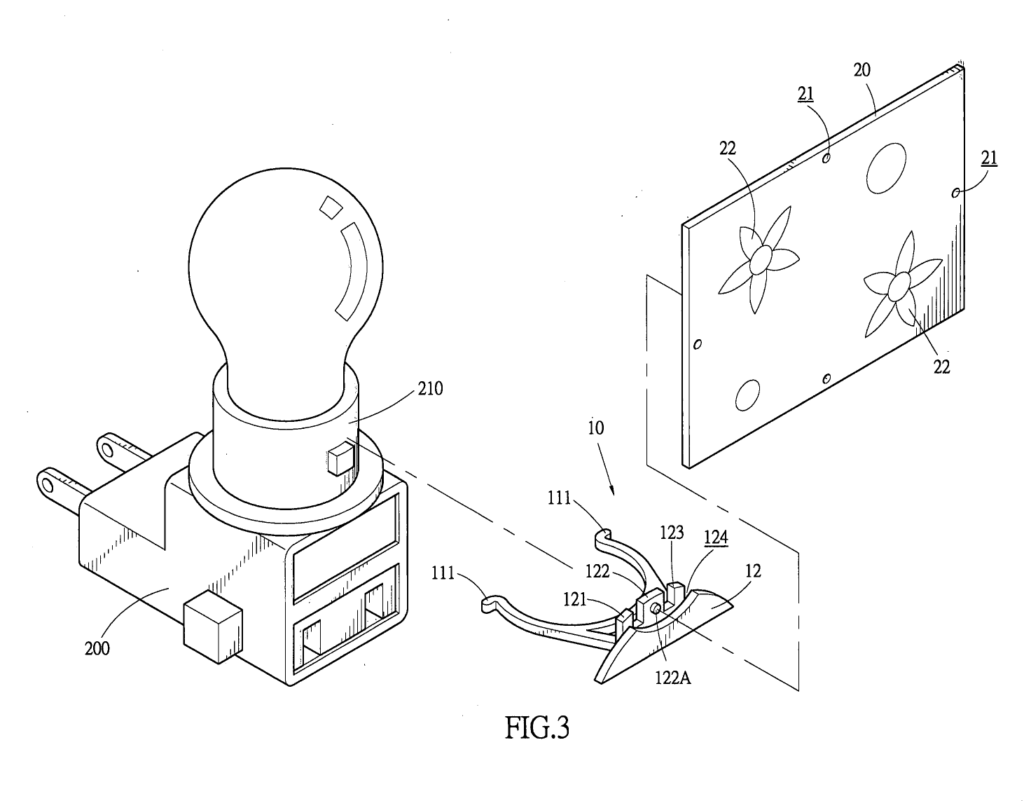

With reference to the drawings and in particular to FIG. 3, a night light constructed in accordance with the present invention, generally designated with reference numeral 200, comprises a light source, such as a light bulb attached to a bulb socket 210. A decoration board, generally designated with reference numeral 100, is selectively and removably attached to the night light 200.

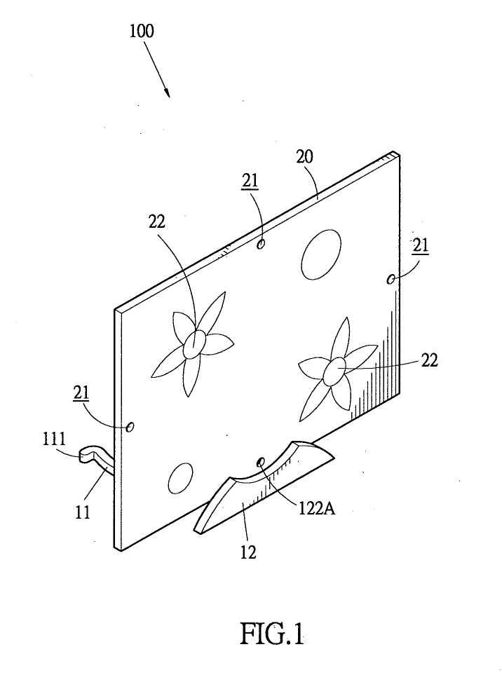

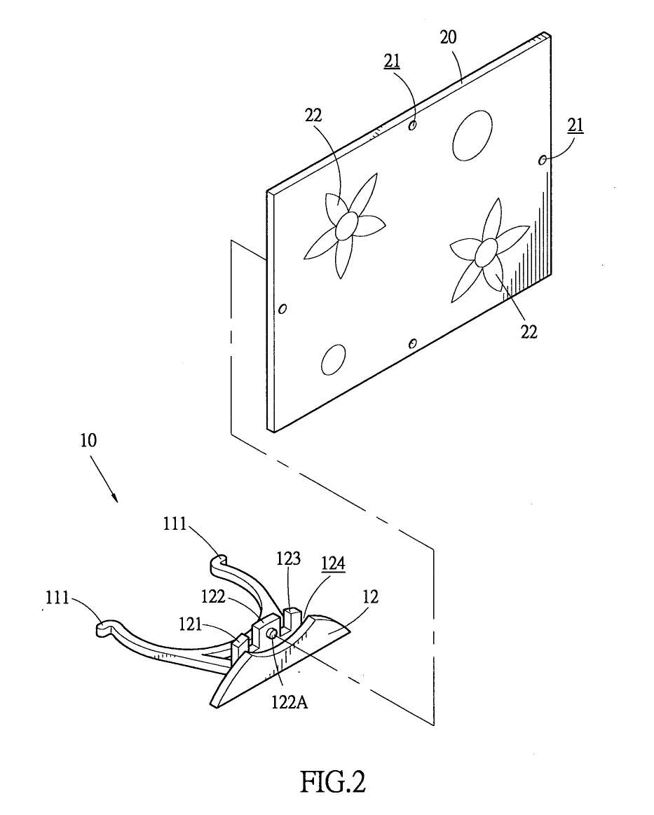

Also referring to FIGS. 1 and 2, the decoration board 100 comprises a mount portion 10 and a board portion 20. The mount portion 10 comprises a clip composed of two curved resilient arms 11, each having a bent end 111, and a receiving section 12 from which the resilient arms 11 extend. The curved configuration of the resilient arms 11 allows the clip to substantially comply with the generally cylindrical configuration of the bulb socket 210 thereby ensuring the secure attachment therebetween. The receiving section 12 comprises a number of resilient retention tabs 121, 122, 123 spaced from the receiving section 12 thereby defining therebetween a receiving slot 124 that receives and retains an edge (not labeled) of the board portion 20 therein. The resiliency of the retention tabs 121, 122, 123 helps retaining the board portion 20 in the slot 124, and also allowing removal of the board portion 20 from the mount portion 10, which will further described.

At least one of the retention tabs, such the retention tab 122 in the embodiment illustrated, is provided with a boss 122A, which is engageable with one of a plurality of holes or dimples 21 defined in the board portion 20 to secure the board portion 20 in the slot 124. By engaging the boss 122A with different ones of the holes 21, the board portion 20 can be positioned at different orientations with respect to the mount portion 10. In the embodiment illustrated, the board portion 20 is rectangular, having four edges, in each of which a hole 21 is defined. This allows any one edge of the board portion 20 to be received and retained in the slot 124 and thus the board portion 20 is selectively positioned at one of four orientations with respect to the mount portion 10.

Patterns 22, such as flowers as shown in the drawings, are formed in surfaces of the board portion 20 whereby when light transmits through the board portion 20, the patterns 22 are projected in a direction where the light travels through the board portion 20. Such patterns 22 may include figures, texts, marks and any planar or raised or recessed patterns.

Referring back to FIG. 3, the clip that is composed of the two resilient arms 11 removably engages around the bulb socket 210 to position the board portion 20 in front the bulb, which allows the light emitted from the bulb to transmit through the board portion 20 and projects the patterns 22 into space in the direction where the light transmits through the board portion 20. The resiliency of the arms 11 helps securing the mount portion 10 and thus the board portion 20 retained in the mount portion 10 to the bulb socket 210. The bent ends 111 of the arms 11 help a user to operate the arms 11 for mounting/dismounting the mount portion 10 to/from the bulb socket 210. Further, the mount portion 10 may be mounted to the bulb socket 210 at any orientation whereby the board portion 20 can be positioned at any desired orientation with respect to the bulb socket 210 so that the patterns 22 can be projected onto any desired space in the desired direction.

The resiliency of retention tabs 121, 122, 123 allows for removal and change of the board portion 20. By disengaging the boss 122A of the retention tab 122 from the hole 21 of the board portion 20, the board portion 20 can be detached from the mount portion 10 whereby a new board portion having different patterns thereon may then be placed in the slot 124 and fixed by the boss 122A.

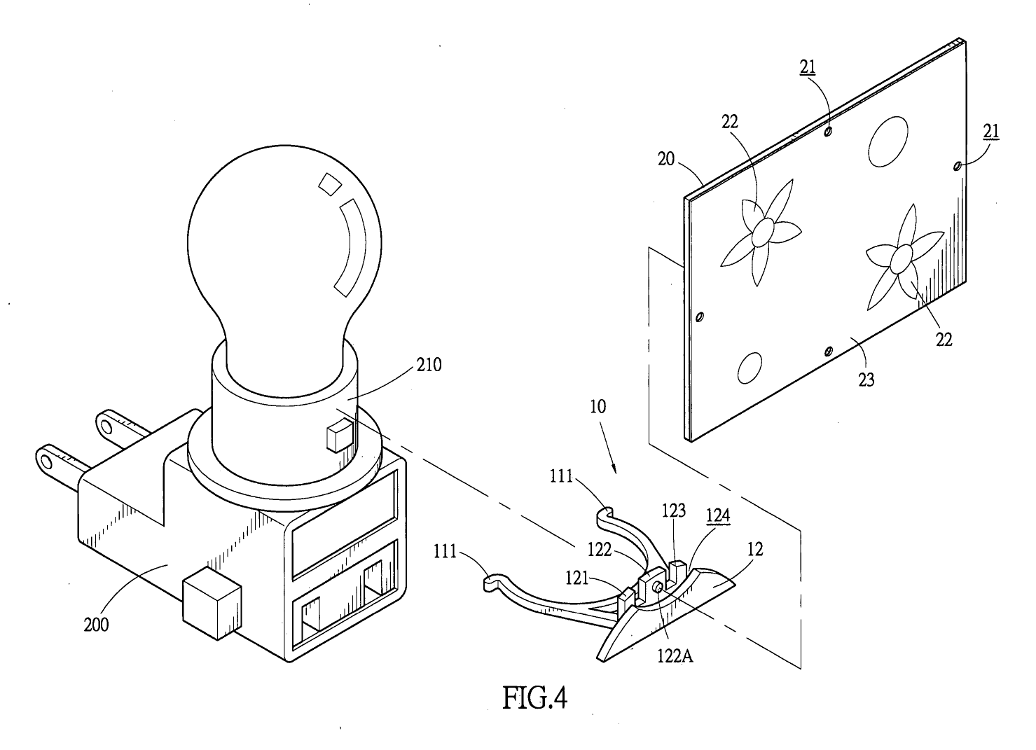

Also referring to FIG. 4, a modification of the board portion 10 is illustrated as a second embodiment of the present invention, wherein a transparent refraction layer 23 is coated on an outside surface of the board portion 20, namely the surface that is away from the bulb when the board portion 20 is attached to the bulb socket 210. The refraction layer 23 is constructed to induce refraction of the projection of the patterns 22 by the light of the bulb. This gives more appealing and vivid effect to the general consumers.

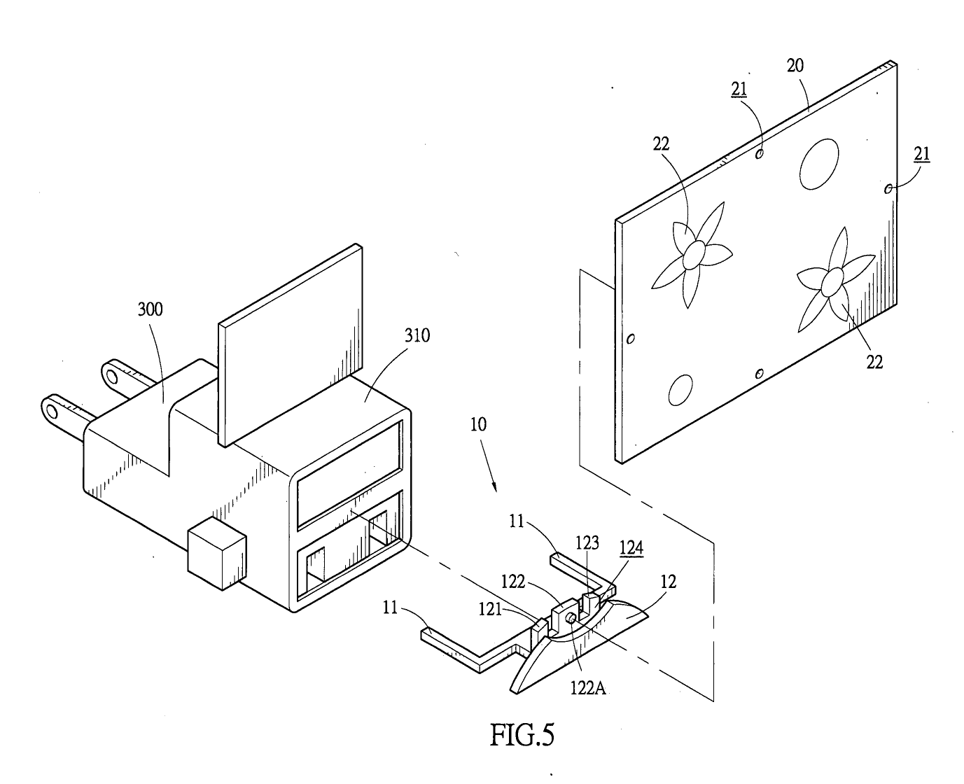

Also referring to FIG. 5, a modification of the mount portion 10 is illustrated as a third embodiment of the present invention, wherein the curved arms 11 of the mount portion 10 shown in FIGS. 1 and 2 are replaced by spaced straight arms 11, preferably still resilient, that extend from opposite ends of the receiving section 12 to form a substantially U-shape. Such a U-shaped configuration allows the clip of the mount portion 10 to attach the mount portion 10 to a base 310 of a cold light panel type light source 300, which generally has a parallelepiped structure.

Although the present invention has been described with reference to the preferred embodiments thereof, it is apparent to those skilled in the art that a variety of modifications and changes may be made without departing from the scope of the present invention which is intended to be defined by the appended claims.

1. A decoration board of a night light assembly comprising:
a mount portion comprising a clip and a receiving section mounted to a remote end side of the clip, the clip adapted to attach the mounting portion to a light source;
a board portion received and retained in the receiving section whereby when the mount portion is attached to the light source, the board portion is positioned in front of the light source to allow light emitted from the light source to transmit therethrough.

2. The decoration board as claimed in claim 1, wherein the clip comprises two spaced straight arms forming a substantially U-shape.

3. The decoration board as claimed in claim 1, wherein the clip comprises two curved arms, each having a bent end.

4. The decoration board as claimed in claim 1, wherein the receiving section comprises at least one resilient retention tab spaced from the receiving section to define a slot that receives an edge of the board portion therein.

5. The decoration board as claimed in claim 4, wherein the retention tab forms a boss engageable with a hole defined in the edge of the board portion to secure the board portion in the receiving slot.

6. The decoration board as claimed in claim 1, wherein the board portion has a surface on which decoration patterns are formed.

7. The decoration board as claimed in claim 6, wherein the decoration patterns comprise planar figures, texts and marks.

8. The decoration board as claimed in claim 6, wherein the decoration patterns comprise raised figures, texts and marks.

9. The decoration board as claimed in claim 1, wherein the board portion comprises a transparent refraction layer formed on a surface thereof.
